(19) United States
(12) Patent Application Publication
(10) Pub. No.: US 2020/0253243 A1
(43) Pub. Date: Aug. 13, 2020

(54) PET FOOD PRODUCT

(71) Applicant: Nslutreco IP Assets B.V, Boxmeer (NL)

(72) Inventors: Scott Fry, Boxmeer (NL); Liz Koutsos, 5831 JN (NL)

(21) Appl. No.: 16/616,934

(22) PCT Filed: May 25, 2018
(86) PCT No.: PCT/NL2018/050345

§ 371 Date: Nov. 25, 2019

Related U.S. Application Data
(60) Provisional application No. 62/511,606, filed on May 26, 2017.

(51) Int. Cl. A23K 20/20; A23K 20/105; A23K 50/48; A23K 50/42; A23K 30/00; C01B 11/14

(52) U.S. Cl. CPC A23K 20/30; A23K 20/105; C01B 11/14; A23K 50/42; A23K 30/00; A23K 50/48

(57) ABSTRACT

This disclosure pertains to a food product comprising a composition comprising a basic metal salt, particularly pet food products, and further pertains to the use of such composition to reduce lipid oxidation and/or discoloration of such food product, particularly wet food products, e.g., during processing and storage.

### CROSS-REFERENCE TO RELATED APPLICATIONS

This application is a national phase entry under 35 U.S.C. § 371 of International Patent Application PCT/NL2018/050345, filed May 25, 2018, designating the United States of America and published as International Patent Publication WO 2018/217091 A2 on Nov. 29, 2018, which claims the benefit under Article 8 of the Patent Cooperation Treaty to U.S. Patent Application Ser. No. 62/511,606, filed May 26, 2017.

### TECHNICAL FIELD

This disclosure pertains to pet food products comprising a trace mineral.

### BACKGROUND

Pet food products generally comprise trace minerals. Trace minerals are generally added to pet food feed to ensure that the animal receives the necessary trace mineral in the required amounts. Examples of such trace minerals include metal sources from copper, zinc and manganese, but also iron, cobalt, magnesium, etc. Commonly used trace mineral sources are metal salts or oxides such as copper sulphate and zinc oxide, for example. Other trace minerals may further include metal amino acid chelates and metal proteinates. Such trace minerals tend to cause undesirable discoloration of the pet food product.

Provided herein is an improved pet food product.

### BRIEF SUMMARY

In a first aspect, this disclosure relates to a pet food product comprising a basic metal salt such as a basic copper salt (e.g., tribasic copper chloride (Cu₂(OH)₃Cl).

In an embodiment relating to the pet food product as taught herein, the basic metal salt may contain at least one metal selected from the group consisting of copper, zinc and manganese, preferably the basic metal salt is a basic copper salt.

In an embodiment relating to the pet food product as taught herein, the pet food product may comprise the basic metal salt in an amount of at least 1 ppm and at most 500 ppm.

In an embodiment relating to the pet food product as taught herein, the pet food product may further comprise taurine.

In an embodiment relating to the pet food product as taught herein, the pet food product may be cat food.

In an embodiment relating to the pet food product as taught herein, the pet food product may be dog food.

In a further aspect, this disclosure relates to a composition comprising a basic copper salt and a basic zinc salt, wherein the weight ratio of the basic copper salt and the basic zinc salt is at least 0.01 and at most 0.5.

In an embodiment relating to the composition as taught herein, the composition may further comprise basic manganese salt.

In an embodiment relating to the composition as taught herein, the weight ratio of the basic copper salt and the basic manganese salt may be at least 0.01 and at most 2.

In a further aspect, this disclosure relates to the use of the composition as taught herein in pet food products.

In a further aspect, this disclosure relates to the use of the composition as taught herein in wet pet food products.

In a further aspect, this disclosure relates to the use of the composition as taught herein in dry pet food products.

In a further aspect, this disclosure relates to the use of the composition as taught herein in cat food products.

In a further aspect, this disclosure relates to the use of the composition as taught herein in dog food products.

In a further aspect, this disclosure relates to the use of the composition as taught herein to reduce lipid oxidation.

In yet another aspect, this disclosure relates to the use of the composition as taught herein to reduce discoloration of pet food products, particularly during processing and/or storage, especially in canned and/or wet pet food products.

### DETAILED DESCRIPTION

The disclosure pertains to a pet food product comprising a composition comprising a basic metal salt. Basic metal salts can be defined by the formula M(OH)_{y}X_{(2-y)/2}, wherein M is a metal cation, X is an anion or anionic complex and y is 1-3 depending on the valency of the anion X. Further details of such basic metal salts can be learnt from WO 00/32206, U.S. Pat. Nos. 5,451,414, and 8,802,180. Such basic metal salts generally have a higher bioavailability than the commonly used trace mineral salts. Moreover, the basic metal salts generally provide a better stability to the pet food product. For instance, the vitamin stability will be improved. In addition, the pet food product of the disclosure exhibits a reduced discoloration during processing and/or storage, especially in canned and/or wet pet food products.

In one embodiment the pet food comprises a composition comprising a basic metal salt, wherein the basic metal salt contains at least one metal selected from the group consisting of copper (e.g., dicopper chloride trihydroxide (‘basic copper chloride’); Cu₂(OH)₃Cl), zinc (e.g., Zinc chloride hydroxide monohydrate; Zn₅(OH)₈Cl₂.H₂O) and manganese (e.g., manganese hydroxychloride—Mn₂(OH)₃Cl), preferably the basic metal salt is a basic copper salt such as basic copper chloride. Preferably, the pet food comprises a composition comprising a basic copper salt. Especially, the conventionally used copper salts like copper sulphate contribute substantially to the discoloration of pet food. By using the basic copper salt instead of the conventional copper salts, this discoloration is considerably reduced or even diminished. This allows for a longer storage stability of the pet food. It is believed that the discoloration is at least partially due to the oxidation of lipids present in the feed. Hence, the disclosure further pertains to the use of the composition of the disclosure to reduce lipid oxidation, preferably to reduce lipid oxidation in animal feed, and most preferably to reduce lipid oxidation in pet food, especially wet pet food.

The disclosure further pertains to pet food comprising a composition comprising at least two basic metal salts. Preferably, the pet food product of the disclosure comprises a composition comprising a basic copper salt and a basic zinc salt. In another embodiment, the pet food product comprises a composition comprising a basic copper salt and a basic zinc salt, wherein the weight ratio of the basic copper salt and the basic zinc salt is at least 0.01 and at most 0.5. This composition can be particularly suitably used in feed for cats and dogs. Due to the presence of two basic metal salts, the composition can be more conveniently added to the animal feed in a pre-defined ratio.

In one embodiment of the disclosure, the weight ratio of basic copper salt and basic zinc salt is at least 0.02, preferably at least 0.03, more preferably at least 0.05 and most preferably at least 0.1, and preferably at most 0.45, more preferably at most 0.40, even more preferably at most 0.35 and most preferably at most 0.30.

The composition in the pet food product of the disclosure may further comprise a basic manganese salt. In one embodiment, the weight ratio of basic copper salt and basic manganese salt is at least 0.01. Preferably, the weight ratio of basic copper salt and basic manganese salt is at least 0.02, preferably at least 0.03, more preferably at least 0.05 and most preferably at least 0.1, and preferably at most 1.8, more preferably at most 1.5, even more preferably at most 1.2 and most preferably at most 1.

The composition may comprise the basic metal salts in an amount of at least 1 percent by weight (wt %), preferably at least 5 wt %, more preferably at least 10 wt %, even more preferably at least 15 wt %, and most preferably at least 20 wt %, and preferably at most 100 wt %, more preferably at most 90 wt %, even more preferably at most 80 wt %, even more preferably at most 70 wt %, and most preferably at most 60 wt %, based on the total weight of the composition.

The basic metal salts in the composition of the disclosure may be present as a physical mixture, i.e., a blend of the basic metal salt powders, or be present in agglomerate particles comprising a digestible binder. The composition of the disclosure can be a blend of agglomerated particles wherein each particle comprises a single basic metal salt. More preferred is a composition of agglomerate particles comprising the basic copper salt and the basic zinc salt, and optionally any other trace mineral. In one embodiment, the composition of the disclosure comprises crystals of the basic copper salt and the basic zinc salt, which are agglomerated with the digestible binder to form digestible agglomerated particles. Preferably, wherein the size of the crystals is from 0.1 μm to 20 μm and the size of the digestible agglomerate particles is from 50 μm to 300 μm. The advantage of these agglomerated particles is the low dust and free flowing properties. In fact, it has been found that together with the low dust levels of the agglomerated particles, the dust particles have a much lower content of the basic metal salt(s) than observed in conventional trace mineral powders. This has a clear safety benefit for both animal and person processing the composition of the disclosure.

The preferred basic copper salt in the composition of the disclosure is basic copper chloride, in particular, atacamite and clinoatacamite. Most preferred is a mixture of atacamite and clinoatacamite. The preferred basic zinc salt is basic zinc chloride, in particular, Simonkoellite. The preferred basic manganese salt is basic manganese chloride, in particular, Kempite. Processes to prepare the aforementioned basic metal salts can be found in U.S. Pat. No. 8,802,180, WO 00/32206 and U.S. Pat. No. 5,451,414, which are herewith incorporated by reference.

In one embodiment, the composition in the pet food product of the disclosure further comprises a digestible binder. The digestible binder can be any suitable digestible binder known in the art and capable of binding the basic metal salt particles to form an agglomerated particle. Examples of such digestible binders include starches such as corn starch, potato starch, rice starch and modified derivatives thereof.

The composition may comprise the digestible binders in an amount of at least 1 percent by weight (wt %), preferably at least 2 wt %, more preferably at least 5 wt %, even more preferably at least 8 wt %, and most preferably at least 10 wt %, and preferably at most 40 wt %, more preferably at most 30 wt %, even more preferably at most 25 wt %, and most preferably at most 20 wt %, based on the total weight of the composition.

The composition of the disclosure may further comprise other trace minerals such as metal salts including basic metal salts based on magnesium, calcium, iron and cobalt, as well as metal chelates, iodine and selenium sources. The composition may further comprise vitamins.

The basic copper salt, the basic zinc salt, the digestible binder and any other component add up to 100 wt % of the total weight of the composition.

The composition of the disclosure includes a premix of pet food and a feed additive. Consequently, the disclosure further pertains to a feed additive comprising the composition of the disclosure, preferably the agglomerated particles of the disclosure. Such a feed additive may comprise further ingredients commonly used in feed additives. The feed additive of the disclosure may be applied and/or added to a premix of pet food and/or to pet food. It may be applied to preserve the premix and/or the feed. The feed additive may further be used to improve the gut health of the pet.

The disclosure further pertains to a premix of pet feed comprising the composition of the disclosure, preferably the agglomerated particles of the disclosure. The premix of the disclosure may comprise further ingredients commonly used in premixes of pet food. The premixes of the disclosure generally are further processed and further ingredients are added to form the pet food product. The pet food product generally comprises nutrients such as fats and/or proteins and/or carbohydrates that are fed to a pet to provide in its metabolic requirements. Pet food can be a nutritionally complete feed (i.e., providing all required nutrients to support a normal metabolism of the pet). Similar ingredients are also contained in a premix of pet food, which, however, contains only part of the required nutrients, and need to be mixed with other nutrients or fed separately from these other nutrients.

The total amount of basic metal salt in the pet food product is generally at most 1000 ppm, preferably at most 600 ppm, and most preferably at most 500 ppm, and preferably at least 1 ppm, more preferably at least 50 ppm and most preferably at least 100 ppm.

The amount of the basic copper salt in the pet food product is generally at most 50 ppm, preferably at most 40 ppm, and most preferably at most 30 ppm, and preferably at least 1 ppm, more preferably at least 5 ppm and most preferably at least 10 ppm.

The amount of the basic zinc salt in the animal feed is generally at most 400 ppm, preferably at most 350 ppm, and most preferably at most 300 ppm, and preferably at least 50 ppm, more preferably at least 80 ppm and most preferably at least 100 ppm.

The amount of the basic manganese salt in the animal feed is generally at most 150 ppm, preferably at most 125 ppm, and most preferably at most 100 ppm, and preferably at least 5 ppm, more preferably at least 10 ppm and most preferably at least 15 ppm.

The individual basic metal salts used in the composition of the disclosure can be prepared using processes described in WO 00/32206 and U.S. Pat. No. 5,451,414. The agglomerated particles of the basic metal salts in accordance with the disclosure can be prepared using techniques disclosed in U.S. Pat. No. 8,802,180, wherein the agglomerated particles comprising two or more basic metal salts are prepared by spray drying dispersions comprising the basic metal salts, the digestible binder and a solvent (generally water).

In one embodiment of the disclosure, the pet food product further comprises taurine.

The pet food product of the disclosure may be cat food. When the pet food product is cat food, further ingredients commonly used in cat food are generally present.

The pet food product of the disclosure may be dog food. When the pet food product is dog food, further ingredients commonly used in dog. food are generally present.

The pet food product of the disclosure can be dry pet food, in particular, dry dog food and dry cat food. Ingredients and further particulars of dry pet food can be found in WO 2015/092680 and WO 2013/074466, which are incorporated herein by reference. The amount of water in dry pet food is low, particularly the amount of water is at most 20 wt %, preferably at most 10 wt %. Generally dry pet food comprises crude proteins include vegetable proteins such as whole grain wheat, whole grain corn and soybean meal; animal proteins such as casein, albumin and meat proteins being, for example, beef, pork, lamb, poultry and fish; meat meals such as rendered and ground parts of beef, pork, lamb, poultry, fish and mixtures thereof; meat and meat by-products.

Dry pet food may further comprise fat including animal fats such as beef fat, pork fat and poultry fat; and vegetable fats such as corn oil, sunflower oil, safflower oil, rapeseed oil soybean oil and olive oil. Additionally, the dry pet feed comprises carbohydrates including grains or cereals such as rice, corn, millet, sorghum, alfalfa, barley, soybeans canola, oats wheat, rye, triticale and mixtures thereof. The dry pet food of the disclosure may further comprise fibers including fibers including beet pulp, gum Arabic, gum talha, psyllium, rice bran, carob bean gum, citrus pulp and pectin.

The dry pet food may further comprise a coating.

The pet food product of the disclosure can be wet pet food, in particular, wet dog food and wet cat food. Ingredients and further particulars of wet pet food can be found in WO 2016/176456, which is included herein by reference. Generally, wet pet food products comprise proteins and water, and optionally starch and fat. More particularly, the wet pet food product comprises 10 to 60 wt % protein, 30 to 90 wt % water, 0 to 15 wt % starch and 0 to 20 wt % fat. The proteins may be animal proteins including proteins originating from vertebrates such as mammals, fowl and fish; and non-animal proteins including vegetable proteins, algal proteins, egg proteins, milk proteins, microbial proteins and insect proteins.

The wet pet food product is generally solid or semi-solid. Preferably, the wet pet food is semi-solid.

The disclosure further pertains to the use of the composition of the disclosure in feeding of pets, in particular, of cats and dogs. In one aspect, the disclosure pertains to a method of feeding a pet, in particular, cats and dogs, by providing to the pet food comprising the composition of the disclosure.

In another aspect, the disclosure pertains to the use of the composition of the disclosure in pet food products. In a further aspect, the disclosure pertains to the use of the composition of the disclosure in wet pet food products. the disclosure pertains to the use of the composition of the disclosure in dry pet food products. In a further aspect, the disclosure pertains to the use of the composition of the disclosure in dog food. In a further aspect, the disclosure pertains to the use of the composition of the disclosure in cat food.

### EXAMPLES

### Example 1

Conventional copper salt (copper sulphate) or basic copper salt (basic copper chloride) were added to a complete animal feed containing 2.5-3.8% added lipid, at levels of 25,100 or 300 mg Cu/kg. The copper source was mixed into animal feed and then stored at 37° C. for 20 days post-mixing. This storage temperature represents ˜2 to 3 months of accelerated storage conditions for animal feed. The susceptibility of each animal feed to lipid oxidation was measured by analyzing primary and secondary lipid oxidation products. Primary lipid oxidation, analyzed using peroxide value, demonstrated a significantly lower level of primary lipid oxidation products for feed containing basic copper salt as compared to feed containing traditional copper salt (p<0.05, Table 1). Secondary lipid oxidation products, analyzed using anisidine levels, demonstrated a significantly lower level of secondary lipid oxidation products for feed containing basic copper salt as compared to feed containing traditional copper salt (p<0.05, Table 2). These data demonstrate that in a complete animal feed, basic copper salt results in lower lipid peroxidation than traditional copper salt.

TABLE 1
Primary lipid oxidation products, measured using peroxide levels,
in animal feed containing traditional mineral salts or basic
mineral salts and stored for up to 20 days at high temperatures.

| | 25 mg Cu/kg | | 100 mg Cu/kg | | 300 mg Cu/kg | |
|---|---|---|---|---|---|---|
| | feed | | feed | | feed | |
| Days | | Basic | | Basic | | Basic |
| of | Copper | copper | Copper | copper | Copper | copper |
| storage | sulphate | chloride | sulphate | chloride | sulphate | chloride |
| 0 | 2.2 | 1.4 | 3.5 | 1.9 | 2 | 1.9 |
| 4 | 57.9 | 22.8 | 240.6 | 26.5 | 270 | 27.9 |
| 8 | 211.9 | 36.1 | 129.4 | 35.5 | 70.3 | 58.7 |
| 16 | 96.5 | 63 | 48.9 | 58.7 | 22.2 | 109.5 |
| 20 | 74.2 | 26.5 | 36.4 | 37.9 | 29.4 | 62.5 |

TABLE 2
Secondary lipid oxidation products, measured using anisidine
levels, in animal feed containing traditional mineral salts or basic
mineral salts and stored for up to 20 days at high temperatures.

| | 25 mg Cu/kg | | 100 mg Cu/kg | | 300 mg Cu/kg | |
|---|---|---|---|---|---|---|
| | feed | | feed | | feed | |
| Days | | Basic | | Basic | | Basic |
| of | Copper | copper | Copper | copper | Copper | copper |
| storage | sulphate | chloride | sulphate | chloride | sulphate | chloride |
| 0 | 34 | 25 | 25 | 35 | 25 | 19 |
| 4 | 128 | 87 | 342 | 99 | 684 | 116 |
| 8 | 421 | 142 | 819 | 152 | 898 | 199 |
| 16 | 289 | 112 | 291 | 191 | 307 | 238 |
| 20 | 326 | 151 | 272 | 162 | 310 | 208 |

1.-16. (canceled)

17. A pet food product comprising:
a basic metal salt.

18. The pet food product of claim 17, wherein the basic metal salt contains at least one metal selected from the group consisting of copper, zinc, and manganese.

19. The pet food product of claim 18, wherein the basic metal salt is a basic copper salt.

20. The pet food product of claim 19, wherein the basic copper salt is Cu₂(OH)₃Cl.

21. The pet food product of claim 17, wherein the basic metal salt is present in an amount of from at least 1 parts per million (ppm) to at most 500 ppm.

22. The pet food product of claim 17, further comprising:
taurine.

23. A composition comprising:
a basic copper salt, and
a basic zinc salt, wherein the weight ratio of the basic copper salt to the basic zinc salt is at least 0.01 and at most 0.5.

24. The composition of claim 23, further comprising:
a basic manganese salt.

25. The composition of claim 24, wherein the basic manganese salt is Mn₂(OH)₃Cl.

26. The composition of claim 24, wherein the weight ratio of the basic copper salt to the basic manganese salt is at least 0.01 and at most 2.

27. A method of using the composition of claim 23, the method comprising:
incorporating the composition into a pet food product.

28. The method according to claim 27, wherein the pet food product is a wet pet food product.

29. The method according to claim 27, wherein the pet food product is a dry pet food product.

30. The method according to claim 27, wherein the pet food product is a cat food product.

31. The method according to claim 27, wherein the pet food product is a dog food products.

32. A method of reducing lipid oxidation of a product comprising a lipid, the method comprising:
utilizing the composition of claim 23 to reduce lipid oxidation in the product.

33. A method of reducing discoloration in a pet food product, the method comprising:
utilizing the composition of claim 23 to reduce discoloration in the pet food product.

34. The method according to claim 33, wherein the composition is utilized during processing and/or storage of the pet food product.

35. The method according to claim 33, wherein the pet food product is a canned and/or wet pet food product.

36. The pet food product of claim 21, further comprising:
taurine.
